(19) United States
(12) Patent Application Publication
(10) Pub. No.: US 2018/0081500 A1
(43) Pub. Date: Mar. 22, 2018

(54) SYSTEMS AND METHODS FOR CONTENT ENGAGEMENT

(71) Applicant: Facebook, Inc., Menlo Park, CA (US)

(72) Inventors: Ergin Erant, San Mateo, CA (US); Eric Desfosses, San Jose, CA (US); Guilherme Carlos De Napoli Ferreira, San Francisco, CA (US); Eric Faller, Denver, CO (US); I Chien Peng, Palo Alto, CA (US); Hadi Abou El Kheir, Santa Clara, CA (US); Z'fardeah Elijah RosnBrick, Redwood City, CA (US); Saurabh Aggarwal, Sunnyvale, CA (US)

(21) Appl. No.: 15/269,808

(22) Filed: Sep. 19, 2016

(51) Int. Cl. G06F 3/0482; H04L 29/08; G06F 17/30

(52) U.S. Cl. CPC G06F 3/0482; H04L 67/18; H04L 67/306; H04L 12/6418; G06F 17/3087; G06F 17/30867; H04L 67/02

(57) ABSTRACT

Systems, methods, and non-transitory computer-readable media can obtain data describing at least one content item from a social networking system. A customized set of reaction options to be provided with the content item can be determined. The customized set of reaction options include a plurality of different options for expressing at least one reaction toward the content item, wherein each reaction is associated with at least a corresponding icon. Both (i) the content item and (ii) at least a portion of the customized set of reaction options are presented through a display interface.

### FIELD OF THE INVENTION

The present technology relates to the field of content presentation. More particularly, the present technology relates to techniques for assisting users engage with content items through their computing devices.

### BACKGROUND

Today, people often utilize computing devices (or systems) for a wide variety of purposes. Users can operate their computing devices to, for example, interact with one another, create content, share content, and access information. Under conventional approaches, content items (e.g., images, videos, audio files, etc.) can be made available through a content sharing platform. Users can operate their computing devices to access the content items through the platform. Typically, the content items can be provided, or uploaded, by various entities including, for example, content publishers and also users of the content sharing platform.

### SUMMARY

Various embodiments of the present disclosure can include systems, methods, and non-transitory computer readable media configured to obtain data describing at least one content item from a social networking system. A customized set of reaction options to be provided with the content item can be determined. The customized set of reaction options include a plurality of different options for expressing at least one reaction toward the content item, wherein each reaction is associated with at least a corresponding icon. Both (i) the content item and (ii) at least a portion of the customized set of reaction options are presented through a display interface.

In an embodiment, the systems, methods, and non-transitory computer readable media are configured to determine that a user operating the computing device has performed an operation to expand the set of reaction options and present the set of reaction options through the display interface in its entirety.

In an embodiment, the systems, methods, and non-transitory computer readable media are configured to obtain information describing the respective counts for each reaction option in the set, wherein a count for a reaction option indicates a number of other users of the social networking system that selected the reaction option for the content item and determine an ordering for the set of reaction options based at least in part on the respective counts.

In an embodiment, the systems, methods, and non-transitory computer readable media are configured to determine the set of reaction options based at least in part on a geographic location corresponding to the computing device.

In an embodiment, the systems, methods, and non-transitory computer readable media are configured to determine the set of reaction options based at least in part on one or more preferences of a user operating the computing device.

In an embodiment, the systems, methods, and non-transitory computer readable media are configured to determine a group corresponding to a user operating the computing device based at least in part on one or more attributes of the user and determine the set of reaction options based at least in part on the group.

In an embodiment, the systems, methods, and non-transitory computer readable media are configured to determine the set of reaction options based at least in part on a holiday or event that is occurring when the content item is presented.

In an embodiment, the systems, methods, and non-transitory computer readable media are configured to determine the set of reaction options based at least in part on content included in the content item.

In an embodiment, the systems, methods, and non-transitory computer readable media are configured to determine the set of reaction options based at least in part on a sentiment determined for the content item.

In an embodiment, the systems, methods, and non-transitory computer readable media are configured to determine that a sponsor has provided a customized set of reaction options to be used for the content item, wherein the customized set of reaction options provided by the sponsor are presented with the content item.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module configured to provide content to users, according to an embodiment of the present disclosure.

FIG. 2 illustrates an example of a client module configured to access content items, according to an embodiment of the present disclosure.

FIG. 3 illustrates an example of a reactions module configured to manage reactions that are available to a user, according to an embodiment of the present disclosure.

FIGS. 4A-C illustrate examples of interfaces through which reactions can be selected, according to an embodiment of the present disclosure.

FIG. 5 illustrates an example process for providing a set of reactions, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Content Engagement

Today, people often utilize computing devices (or systems) for a wide variety of purposes. Users can operate their computing devices to, for example, interact with one another, create content, share content, and access information. Under conventional approaches, content items (e.g., images, videos, audio files, etc.) can be made available through a content sharing platform. Users can operate their computing devices to access the content items through the platform. Typically, the content items can be provided, or uploaded, by various entities including, for example, content publishers and also users of the content sharing platform.

In various embodiments, a user can access the social networking system, for example, through a software application running on a computing device. Moreover, the user can access and interact with various content items that are available through the social networking system using an interface provided by the software application. In some embodiments, such content items may be accessed through a content feed (or news feed) that includes various content items determined to be relevant, or of interest, to the user. Under conventional approaches, the user can endorse or “like” a content item through the social networking system, for example, by selecting a “like” button that corresponds to the content item. The “like” option may be selected by users to express their reaction toward a content item or to indicate their acknowledgment of the content item. The use of a “like” option, however, may not always be appropriate. For example, the “like” option may not be appropriate for a content item that describes a tragic event. In this example, users may hesitate to express their reaction (e.g., provide feedback) towards the content item because they may not want their use of the “like” expression to be misinterpreted as their like of the tragic event. Consequently, these users may opt to not “like” the content item at all, which can reduce the amount of user feedback that is collected by the social networking system. Since signals such as liking, commenting on, and/or sharing a content item can be used for scoring and ranking the content item, the loss of such user feedback can affect the optimal operation of the social networking system. Some conventional approaches may allow users to select options to up-vote or down-vote content items. However, providing users with options to up-vote or down-vote content items still does not take advantage of the various other types of user reactions that may be captured for content items. For example, in addition to liking or disliking a content item, a user may also want to express other reactions such as happiness, sadness, disbelief, and laughter, to name some examples. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, users can select one of many different types of reaction icons to express their reaction (e.g., provide feedback) toward content items. In some embodiments, a reaction icon can be used to express an idea, opinion, thought, feeling, and/or emotion. An example set of reactions, therefore, may include a “happy” reaction, a “sad” reaction, an “angry” reaction, a “shock” reaction, and/or a “love” reaction. Naturally, there may be many different types of reactions that are available for use in the social networking system. Each reaction can be associated with a set of attributes or features. Some example attributes include a text label, an icon or emoji, an animation sequence, and/or sound, to name some examples. In some embodiments, users can be restricted to using a customized set of reactions. For example, a reaction can be customized for a user, a group of users (e.g., category of users, age range(s), gender, etc.), a content item (e.g., based on a sentiment analysis of the content item), and/or a geographic region (e.g., zip code, city, state, country, continent, etc.). In one example, the global set of reactions can include a “happy” reaction, a “sad” reaction, an “angry” reaction, a “shock” reaction, and/or a “love” reaction. In this example, a first user may be permitted to use the “happy” reaction, the “sad” reaction, and the “love” reaction while a second user may be permitted to use all of the example reactions. In some embodiments, reactions that are not available for a user to select are not shown as options to the user when the user is accessing content items.

Providing users with multiple options for reacting to content items can, therefore, help improve the rate at which users actively engage with content items through the social networking system. The customization of such reactions can also contribute to this effort. By allowing users to select from multiple options for reacting to content items, more signals that describe user reactions toward content items can be obtained and such signals may, for example, be used to provide users with more optimal content recommendations. In various embodiments, the social networking system can store and manage a global set of reactions that are available for use by users. This global set of reactions can be provided to, or downloaded by, computing devices of users that are used to access the social networking system. In one example, a computing device of a user can automatically download any updates to the global set of reactions upon execution of a social networking application on the computing device or at pre-defined time intervals.

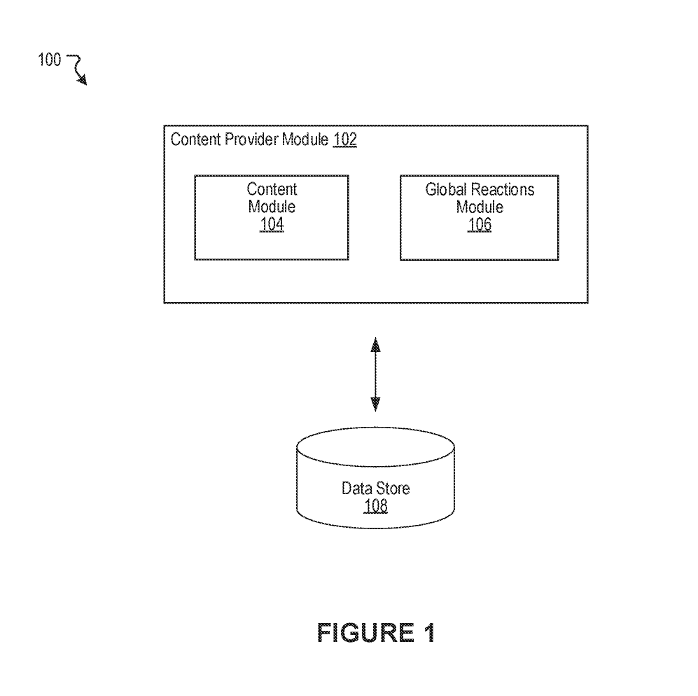

FIG. 1 illustrates an example system 100 including an example content provider module 102 configured to provide content items to users, according to an embodiment of the present disclosure. As shown in the example of FIG. 1, the content provider module 102 can include a content module 104 and a global reactions module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

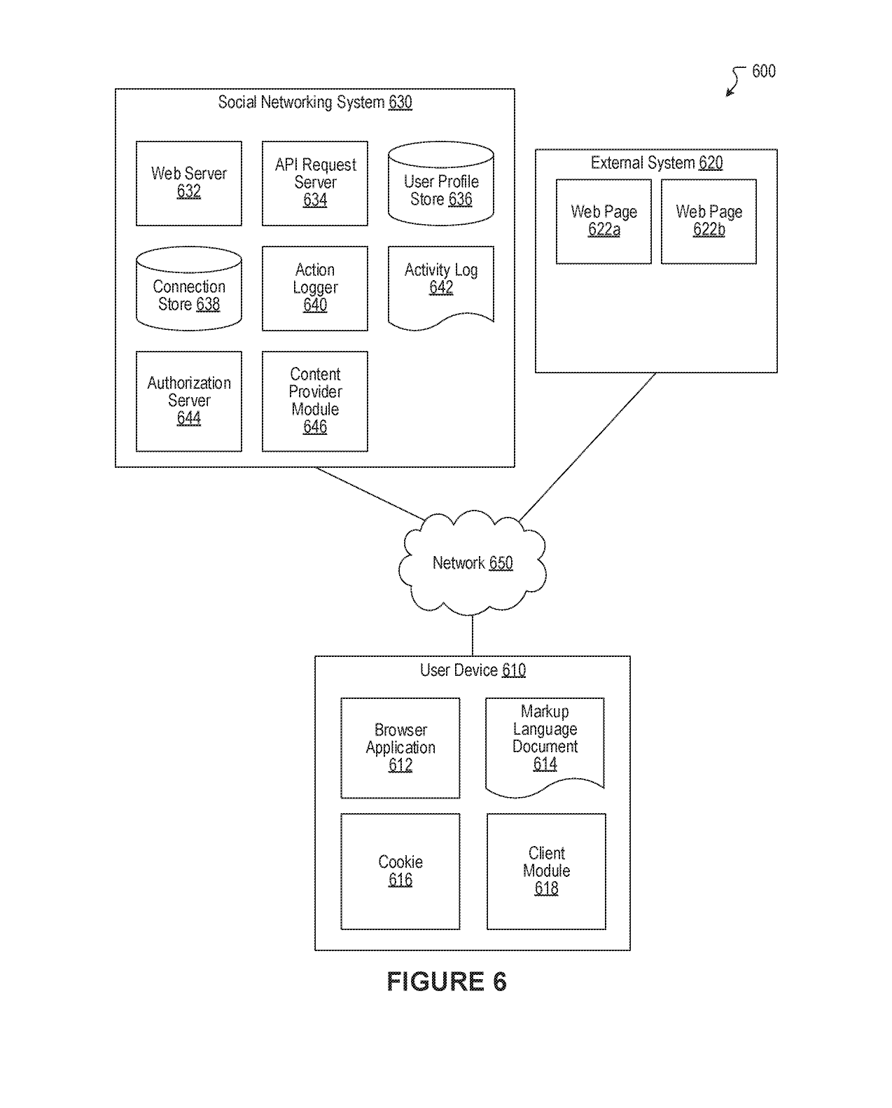

In some embodiments, the content provider module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user computing device or client computing system. For example, the content provider module 102, or at least a portion thereof, can be implemented as or within an application (e.g., app), a program, or an applet, etc., running on a user computing device or a client computing system, such as the user device 610 of FIG. 6. Further, the content provider module 102, or at least a portion thereof, can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 630 of FIG. 6. It should be understood that there can be many variations or other possibilities.

In various embodiments, users can interact with the content provider module 102 using their respective computing devices (e.g., the user device 610 of FIG. 6). For example, the content module 104 can be configured to provide various types of content items to a computing device of a user. Such content items can then be presented to the user through an interface provided through a display screen of the computing device of the user. In some embodiments, a user can access a content feed that is customized for the user. The user's content feed can be configured to include a ranked set of content items that were determined to be of interest to the user. For example, the content module 104 can train (and retrain) machine learning models for ranking content items for potential presentation in content feeds of users of a social networking system. For example, the content module 104 can divide its users into different sets of users based on the various attributes of the users (e.g., age, interests, language, etc.) and can generate one or more models for each set of users. Users with different attributes may have different behavioral patterns that can reflect their interests in different topics reflected by content items. As a result, different models for ranking content items for different sets of users can provide more accurate ranking of content items and provide higher likelihood that users will be interested in the content items presented to them. In some embodiments, the features used to train the models can include interactions of users with content items of a content feed. Such interactions can include, for example, selecting a link in the content item, commenting on the content item, selecting one or more reactions toward the content item, providing a particular reaction in response to the content item, sharing the content item with other entities (e.g., other users of the social networking system, social connections or “friends”, etc.), and hiding the content item. The content module 104 can use the models for each set of users to determine levels of interest of a user for various content items. Content items having a ranking that satisfies a selected threshold value can be presented to the user in her customized content feed. In some embodiments, the models and/or attributes corresponding to users can be used to determine which reaction icon(s) are accessible by a user and which reaction icon(s) are available to the user for viewing only.

The global reactions module 106 can be configured to store and manage data describing a global set of reactions that are available through the social networking system. As mentioned, in some embodiments, users can be restricted to using a customized set of reactions. The customization of a reaction may involve customizing one or more attributes and/or attribute values that are associated with the reaction. In various embodiments, a set of reactions can be presented to a user when the user is accessing content items through the social networking system. Each story, or content item, can be associated with its own set of reactions. The set of reactions (e.g., respective text label, icon, animation, etc.) for a content item can be shown to a user when the user accesses or views the content item. The set of reactions for the content item can indicate, for example, the number of users that have selected a particular reaction. In some embodiments, the respective sizes of the reaction icons that are displayed with a content item vary based on the respective number of users that have selected the reaction. For example, if 10,000 users have selected a “happy” reaction option while only 1,000 users have selected a “sad” reaction option, then the icon for the “happy” reaction can appear larger than the “sad” reaction option. While viewing a story, the user can select one of the reactions associated with the story to express their reaction toward the story. In some embodiments, a story is presented with a default reaction option (e.g., “like” reaction). In such embodiments, the user can access the remaining reactions that are available to the user, for example, by selecting an expand option or by performing a long-press of the default reaction option (e.g., pressing the default reaction option for a threshold period of time).

In some embodiments, a reaction, or set of reactions, can be customized for a user or by the user. For example, a user may configure their social networking profile so that the “love” reaction is never shown as an option for reacting to content items. In another example, reactions may automatically be customized for the user based on the geographic location or region (e.g., zip code, neighborhood, city, state, country, continent, etc.) in which the user resides or is located. In some embodiments, a reaction, or set of reactions, can be customized for a group of users. A group of users may be defined, for example, based on demographics (e.g., age group, gender, etc.), geographic location in which a user resides or is located, and/or categories that correspond to users (e.g., interests, hobbies, etc.). In one example, a “laugh” reaction may appear with the text “haha” for users that are older than age 30. In contrast, the same “laugh” reaction may appear with the text “lulz” for users that are in the 15-29 age range. In another example, the “laugh” reaction may include a “haha” text label for users located in an English-speaking country but may include a “jeje” text label for users located in a Spanish-speaking country. In some embodiments, reactions can be customized based on a user's specified language preference or associated geographic location. For example, users located in the first country may prefer to use a “love” reaction to indicate their strong like of a content item. In contrast, users located in the second country may prefer to have a “super like” reaction to express their strong like of a content item rather than a reaction that is labeled “love”. In this example, both the “love” reaction and the “super like” reaction can be used to express the same reaction. However, the labels for these reactions (i.e., “love” and “super like”) in this example have been customized, for example, based on the preferences, customs, practices, and/or cultural beliefs of the users' country of residence.

In some embodiments, a reaction, or set of reactions, can be customized based on a content item. For example, the reaction(s) may be customized based on the type of content in the content item. In this example, various techniques such as image classification and/or sentiment analysis can be applied to determine the type (e.g., topic, subject, etc.) of content included in the content item. The reactions that are available as options to a user can vary based on this analysis. For example, a user that is viewing a content item, or post, that includes a picture of a food item may be presented with a “yum” or “delicious” reaction option and/or a “gross” or “not delicious” reaction option that allow the user to express their positive or negative reaction toward the food item. In some embodiments, such image classification and/or sentiment analysis of content items can be used to train one or more models for predicting user reactions toward content items. For example, a model may predict that users are likely to react to a content item with an “angry” reaction as opposed to a default “like” reaction. In this example, the “like” reaction may be replaced with the “angry” reaction as the default reaction option. In some embodiments, such prediction information may be used to re-order the set of reactions that are presented to the user, for example, with the icon of reactions that are more likely to be selected being ranked, or positioned, before other reactions. For example, the set of reactions can be ordered so that the “angry” reaction icon is shown before the “like” reaction icon.

In some embodiments, reactions can be customized based on time (e.g., morning, afternoon, evening, late night, etc.), day (e.g., day of the week, month, year), holiday (e.g., New Year's Day), season, and/or event (e.g., Election Day). In some embodiments, a user can provide data describing one or more customized reactions. For example, the user may create their own text label, icon(s), animation(s), and/or sound(s) for a reaction and provide such information to the social networking system. The social networking can then provide the user with options for selecting their customized reaction(s) as described. In general, a set of reactions that were customized by a user are available for use by that user only. However, other users of the social networking system are able to view such customized reactions when the authorized user selects them for content items that are available through the social networking system. In some embodiments, users can share their customized reactions with other users of the social networking system. In some embodiments, reactions can be modified and/or re-ordered based on usage. For example, reactions that are not used at a threshold rate or frequency by a user may not be shown to the user as options. In another example, reactions that are used more frequently can be ranked, or positioned, before other reactions in a set of reactions that are presented to a user for selection. In some embodiments, a set of reactions can be sponsored, for example, by a user, a third-party entity, or an advertiser. In some embodiments, a set of reactions can be sponsored for certain types of content items or posts. For example, an organization that wants to promote their business can create a customized set of reactions for users to use. The social networking system may be configured to present this customized set of reactions for certain content items that satisfy pre-defined criteria (e.g., a certain topic, subject, theme, sentiment, type of content, identity of the user posting the content item, etc.).

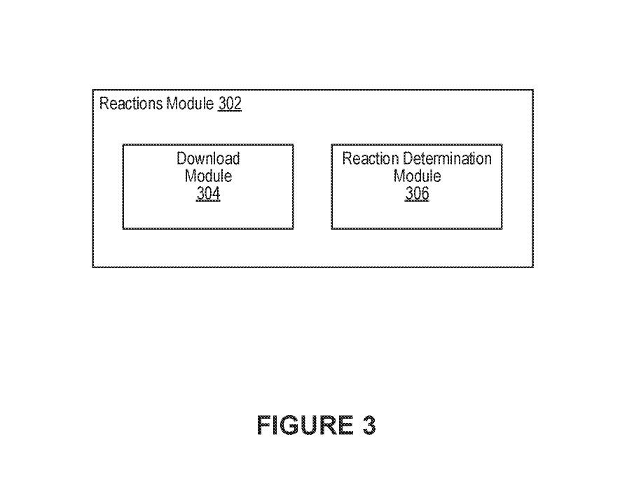

Other attributes of reactions can similarly be customized. For example, a first icon or emoji for the “laugh” reaction may be shown to a first set of users and a different icon or emoji for the “laugh” reaction may be shown to a second set of users. In another example, a first animation sequence for the “laugh” reaction may be shown to a first set of users and a different animation sequence for the “laugh” reaction may be shown to a second set of users. In yet another example, a first sound for the “laugh” reaction may be played for a first set of users and a different sound for the “laugh” reaction may be played for a second set of users. The global reactions module 106 can also be configured to provide the global set of reactions to computing devices being operated by users, as described in reference to FIG. 3.

In some embodiments, the content provider module 102 can be configured to communicate and/or operate with the at least one data store 108 in the example system 100. The at least one data store 108 can be configured to store and maintain various types of data. In various embodiments, the at least one data store 108 can store data relevant to function and operation of the content provider module 102. One example of such data is content items that are available for access through the content provider module 102. Another example of such data is the global set of reactions, contextual information for reactions (e.g., rules governing which reactions are available for use by users of the social networking system), etc. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data. It should be appreciated that there can be many variations or other possibilities.

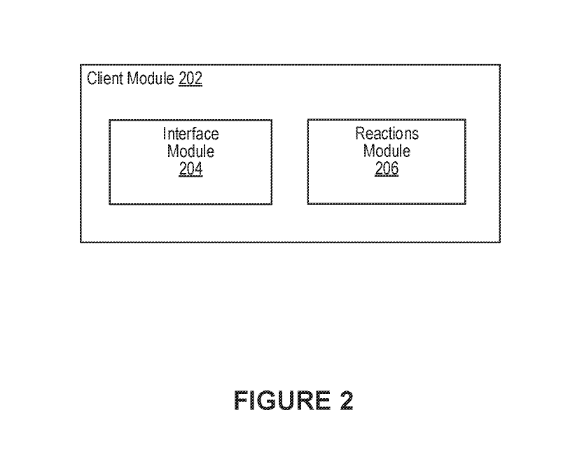

FIG. 2 illustrates an example of a client module 202 configured to access content items, according to an embodiment of the present disclosure. The client module 202 may be implemented as or within an application (e.g., app), a program, or an applet, etc., running on a user computing device or a client computing system, such as the user device 610 of FIG. 6. As shown in FIG. 2, the client module 202 can include an interface module 204 and a reactions module 206.

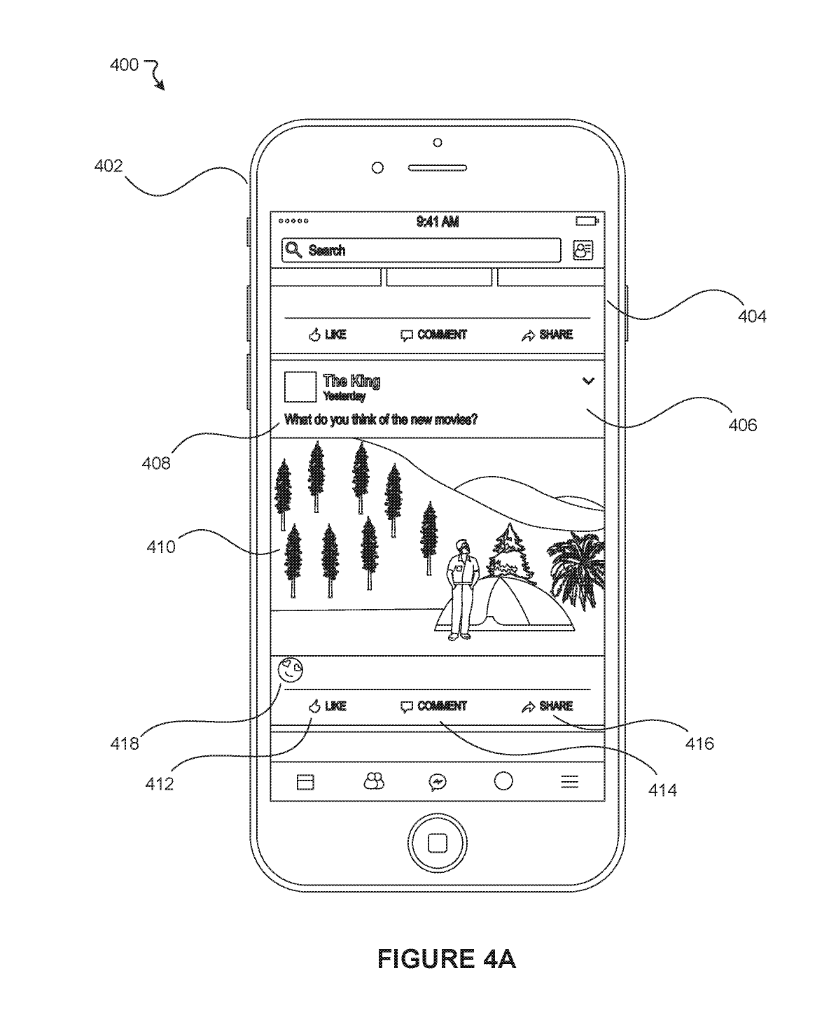

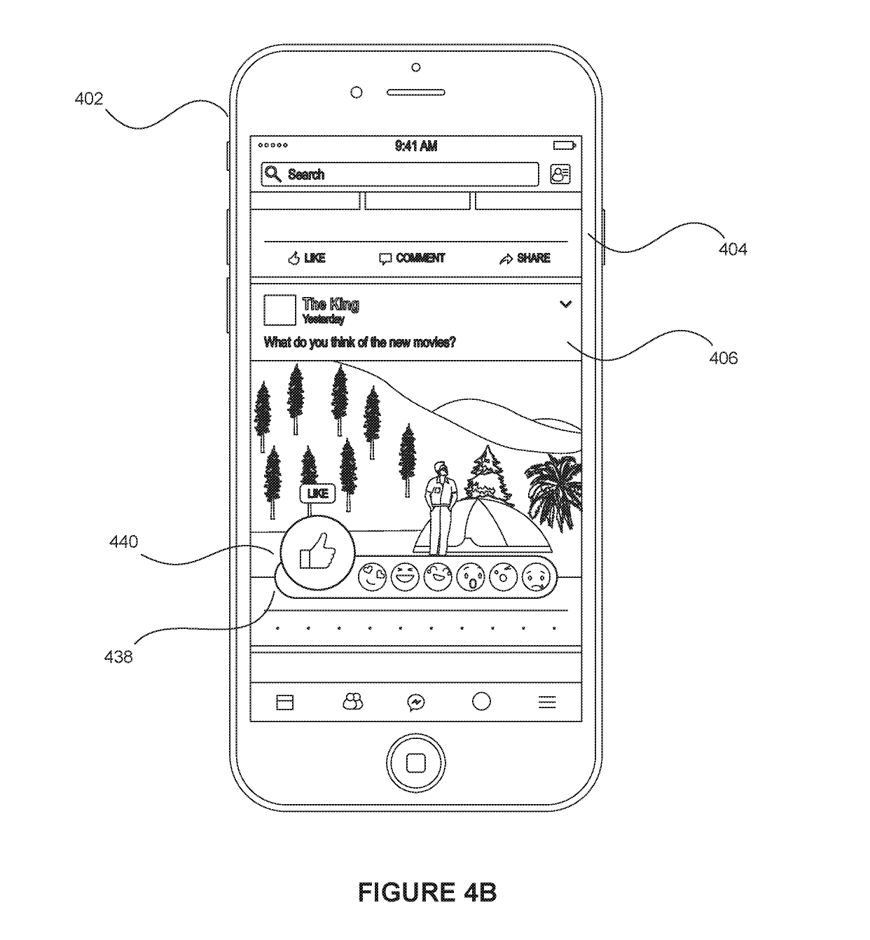

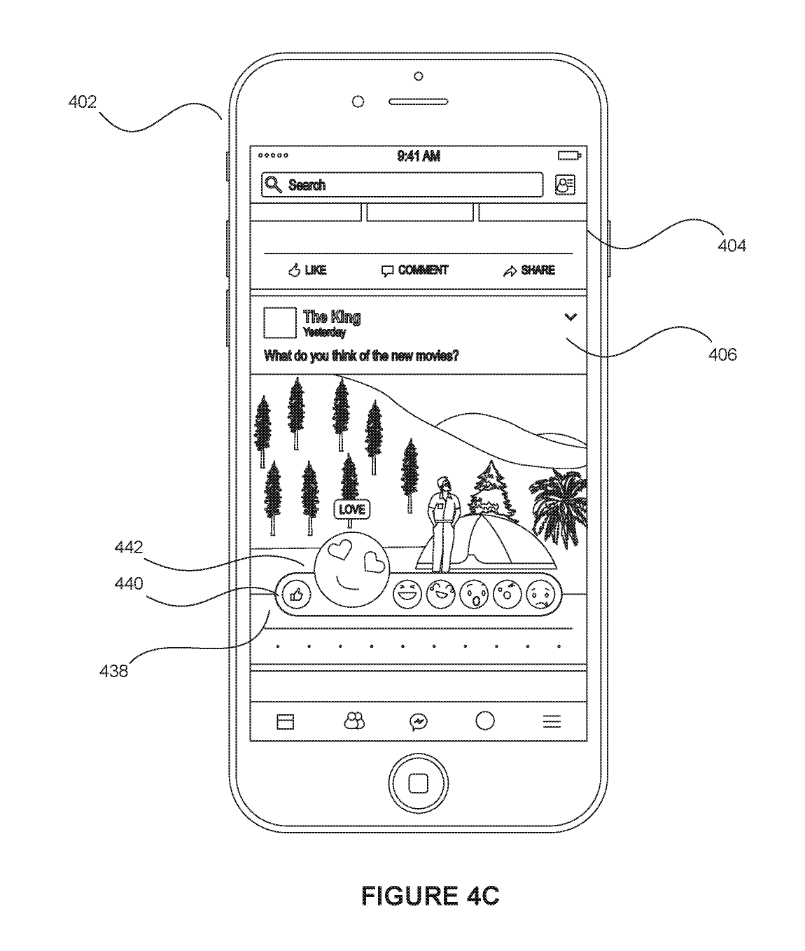

The interface module 204 can be configured to provide an interface (e.g., graphical user interface) through which content items (e.g., images, videos, audio files, etc.) can be presented. Such content items may have been posted to the social networking system (e.g., the social networking system 630 of FIG. 6), for example, by users of the social networking system and/or from various content publishers. The interface can be provided by a software application running on a computing device and through a display screen associated with the computing device. The user can interact with the interface, for example, by performing touch screen gestures through a display screen of the computing device or using some other input apparatus (e.g., mouse). In some embodiments, content items can be presented through the interface as part of a content feed, which the user can navigate to access different content items. Each content item presented can be displayed with a set of reactions that the user can select to react to the content item (e.g., provide feedback), as illustrated in FIGS. 4A and 4B.

The reactions module 206 can be configured to manage the various reactions that are available to the user operating the computing device. As mentioned, the reactions that are available to the user for engaging with a given content item may be customized based on various criteria. More details regarding the reactions module 206 will be provided below in reference to FIG. 3.

FIG. 3 illustrates an example of a reactions module 302 configured to manage reactions that are available to a user, according to an embodiment of the present disclosure. In some embodiments, the reactions module 206 of FIG. 2 can be implemented as the reactions module 302. The reactions module 302 may be implemented as or within an application (e.g., app), a program, or an applet, etc., running on a user computing device or a client computing system, such as the user device 610 of FIG. 6. As shown in FIG. 3, the reactions module 302 can include a download module 304 and a reaction determination module 306.

As mentioned, the global reactions module 106 of FIG. 1 can be configured to store and manage a global set of reactions that are available for use by users of the social networking system. The global set of reactions can include many different types of reactions and/or variations of reactions. In some embodiments, all users of the social networking system can use any of the reactions that are available in the global set of reactions. In some embodiments, the reactions, or set of reactions, that are available for use by a given user can be customized, as described above. As mentioned, a set of reactions can be presented to a user when the user is accessing content items through the social networking system. Each story, or content item, can be associated with its own set of reactions. The set of reactions (e.g., respective text label, icon, animation, etc.) for a content item can be shown to users when the users access or view the content item.

In some embodiments, the set of reactions for a content item may be accessible in other situations. For example, a first user may provide a comment with respect to a content item. In this example, a second user may be provided with options for reacting to the comment while accessing the content item. In some embodiments, reaction options presented to a user for reacting to a comment can be customized based on the content of the comment. Such customization can involve, for example, image classification and/or sentiment analysis of the comment, as described above. Once a user selects a reaction, the reactions module 302 can send information describing such actions to the social networking system including, for example, which reaction was selected and in what context the reaction was selected (e.g., reaction to a content item, reaction to a comment for a content item, etc.). In various embodiments, the social networking system can use this reactions feedback to adjust the scores, or ranking, of various content items. In such embodiments, each reaction option can be weighted appropriately so as to optimize the ranking of content items, for example, based on the reactions that were selected for those content items.

In various embodiments, the download module 304 can be configured to obtain, or download, data describing the global set of reactions from the global reactions module 106. For example, a computing device on which the reactions module 302 is implemented can automatically obtain data describing the global set of reactions and/or any updates (e.g., diffs) to the global set of reactions since the previous download. The reactions module 302 can update the global set of reactions, for example, upon execution of a social networking application on the computing device or at pre-defined time intervals (e.g., every 30 minutes, hourly, daily, weekly, etc.). In various embodiments, each reaction included in the global set of reactions can be associated with context information indicating any criteria that needs to be satisfied before that reaction is permitted to be used by a given user. This criteria can restrict use of a reaction based on any of the approaches described herein. For example, the criteria can restrict use of a reaction based on a user's attributes, temporal restrictions, the content item being accessed, to name some examples. By storing the global set of reactions on the computing device on which the download module 304 is implemented, the social networking system is able to control which reactions are available for use by a user using the context information (e.g., criteria, rules, etc.) that is managed server-side by the content provider (e.g., social networking system). This client-server based approach for providing data describing reactions also allows cross-compatibility between different versions of the software application used for interacting with the social networking system. That is, a first user that is accessing an older version of the software application can still access and/or view reactions that were provided with an updated version of the software application.

In various embodiments, the reaction determination module 306 can determine a set of reactions that are available for use by a user operating the computing device on which the reactions module 302 is implemented. In some embodiments, this determination of the set of reactions may be performed for each content item that the user accesses. For example, the reaction determination module 306 can obtain various attributes that describe the user and/or user preferences (e.g., language preferences), for example, based on the user's social networking profile, and use this information to determine which reactions have been designated for use by such users. The reaction determination module 306 can also determine any other factors that may affect which reactions are available for use including, for example, the user's geographic location, the time of day, the day, any holidays and/or events associated with the day, etc. Once determined, the set of reactions can be displayed along with the content item so that the user can select one or more reactions in response to a content item.

In some embodiments, the reactions module 302 can be configured to allow the user to perform various operations through the social networking system using reactions. For example, the user can search for content items available through the social networking system by specifying one or more reactions as the query. In this example, the user may specify a “cute” reaction as the query and, in response, the social networking system can search and provide the user with a set of content items for which other users selected the “cute” reaction. In some embodiments, this set of content items can be ranked, for example, based on the number of users that selected the specified “cute” reaction for a content item.

FIG. 4A illustrates an example 400 of an interface 404 through which reactions can be selected, according to an embodiment of the present disclosure. The interface 404 is presented through a display screen of the computing device 402. Further, the interface 404 may be provided through an application (e.g., a web browser, a social networking application, etc.) running on the computing device 402. The application can include an in-app browser that is configured to render content items (e.g., parse markup language, run executable code, etc.) that are accessed through the social networking system so that the content items can be presented through the interface 404.

In the example of FIG. 4A, a content item (e.g., post) 406 is being presented through the interface 404. The content item 406 was posted by a user of the social networking system and includes corresponding text 408 and an image 410. A user operating the computing device 402 can interact with the content item 406 by selecting a default reaction (e.g., “like” button) 412, posting a comment 414, and/or sharing 416 the content item 406. In some embodiments, the interface 404 can display icons 418 for reactions that were selected by other users when reacting to the content item 406. In some embodiments, the user can expand the default reaction 412 to expose the other types of reactions that are available for the user to use. For example, the user can select and hold the default reaction 412 for a threshold period of time (e.g., long-press) to view other types of reactions that are available for the user to use, as described in reference to FIGS. 4B and 4C.

For example, in FIG. 4B, the user operating the computing device 402 has performed an operation to expose the other types of reactions and, in response, the interface 404 has been updated to display a set of reactions 438 (e.g., a reactions options menu). The set of reactions 438 can be customized as described above. In some embodiments, the sizes of the respective reaction icons in the set 438 can change as the user navigates the set of reactions. In one example, the icon for the reaction 440 is enlarged with respect to other reactions in the set 438 while the user is activating the reaction icon 440, for example, by performing a tap-and-hold gesture or by hovering an input apparatus pointer (e.g., mouse) in a region of the display screen that corresponds to the reaction icon 440. In some embodiments, an animation sequence associated with a reaction is shown while the reaction is activated. In some embodiments, the respective icons of other reactions in the set 438 can similarly be enlarged as the user navigates across the set of reactions 438, for example, while performing the tap-and-hold gesture (or holding the mouse button). In the example of FIG. 4C, the user operating the computing device 402 has navigated across the set of reactions 438 to a second reaction 442 and, in response, the size of the icon 440 for the “like” reaction has returned to its original size while the size of the icon 442 for the “love” reaction is shown as being enlarged.

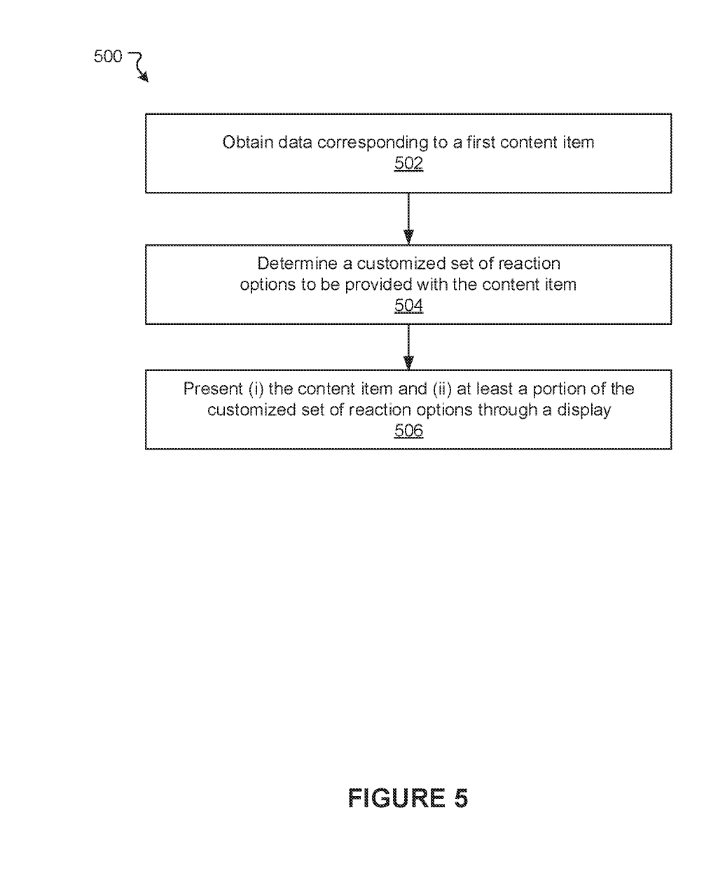

FIG. 5 illustrates an example process 500 for providing a set of reactions, according to various embodiments of the present disclosure. It should be appreciated that there can be additional, fewer, or alternative steps performed in similar or alternative orders, or in parallel, within the scope of the various embodiments discussed herein unless otherwise stated.

At block 502, data describing at least one content item is obtained from a social networking system. At block 504, a customized set of reaction options to be provided with the content item is determined. The customized set of reaction options include a plurality of different options for expressing at least one reaction toward the content item, wherein each reaction is associated with at least a corresponding icon. At block 506, both (i) the content item and (ii) at least a portion of the set of reaction options are presented through a display interface.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102 of FIG. 1. The user device 610 can include a client module 618. The client module 618 can, for example, be implemented as the client module 202 of FIG. 2. As discussed previously, it should be appreciated that there can be many variations or other possibilities.

### Hardware Implementation

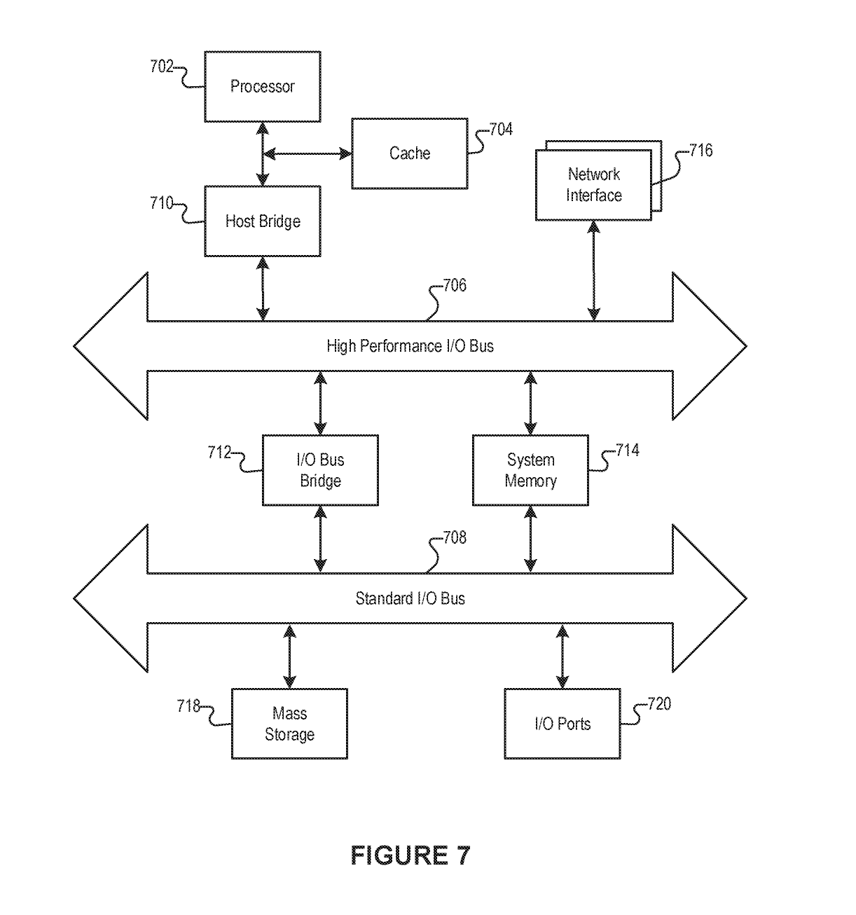

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing device, data describing at least one content item from a social networking system;
determining, by the computing device, a customized set of reaction options to be provided with the content item, the customized set of reaction options including a plurality of different options for expressing at least one reaction toward the content item, wherein each reaction is associated with at least a corresponding icon; and
presenting, by the computing device, (i) the content item and (ii) at least a portion of the customized set of reaction options through a display interface.

2. The computer-implemented method of claim 1, the method further comprising:
determining, by the computing device, that a user operating the computing device has performed an operation to expand the set of reaction options; and
presenting, by the computing device, the set of reaction options through the display interface in its entirety.

3. The computer-implemented method of claim 1, wherein determining the set of reaction options further comprises:
obtaining, by the computing device, information describing the respective counts for each reaction option in the set, wherein a count for a reaction option indicates a number of other users of the social networking system that selected the reaction option for the content item; and
determining, by the computing device, an ordering for the set of reaction options based at least in part on the respective counts.

4. The computer-implemented method of claim 1, wherein determining the set of reaction options further comprises:
determining, by the computing device, the set of reaction options based at least in part on a geographic location corresponding to the computing device.

5. The computer-implemented method of claim 1, wherein determining the set of reaction options further comprises:
determining, by the computing device, the set of reaction options based at least in part on one or more preferences of a user operating the computing device.

6. The computer-implemented method of claim 1, wherein determining the set of reaction options further comprises:
determining, by the computing device, a group corresponding to a user operating the computing device based at least in part on one or more attributes of the user; and
determining, by the computing device, the set of reaction options based at least in part on the group.

7. The computer-implemented method of claim 1, wherein determining the set of reaction options further comprises:
determining, by the computing device, the set of reaction options based at least in part on a holiday or event that is occurring when the content item is presented.

8. The computer-implemented method of claim 1, wherein determining the set of reaction options further comprises:
determining, by the computing device, the set of reaction options based at least in part on content included in the content item.

9. The computer-implemented method of claim 1, wherein determining the set of reaction options further comprises:
determining, by the computing device, the set of reaction options based at least in part on a sentiment determined for the content item.

10. The computer-implemented method of claim 1, wherein determining the set of reaction options further comprises:
determining, by the computing device, that a sponsor has provided a customized set of reaction options to be used for the content item;
wherein the customized set of reaction options provided by the sponsor are presented with the content item.

11. A system comprising:
at least one processor; and
a memory storing instructions that, when executed by the at least one processor, cause the system to perform:
obtaining data describing at least one content item from a social networking system;
determining a customized set of reaction options to be provided with the content item, the customized set of reaction options including a plurality of different options for expressing at least one reaction toward the content item, wherein each reaction is associated with at least a corresponding icon; and
presenting (i) the content item and (ii) at least a portion of the customized set of reaction options through a display interface.

12. The system of claim 11, wherein the system further performs:
determining that a user operating the computing device has performed an operation to expand the set of reaction options; and
presenting the set of reaction options through the display interface in its entirety.

13. The system of claim 11, wherein determining the set of reaction options further causes the system perform:
obtaining information describing the respective counts for each reaction option in the set, wherein a count for a reaction option indicates a number of other users of the social networking system that selected the reaction option for the content item; and
determining an ordering for the set of reaction options based at least in part on the respective counts.

14. The system of claim 11, wherein determining the set of reaction options further causes the system perform:
determining the set of reaction options based at least in part on a geographic location corresponding to the computing device.

15. The system of claim 11, wherein determining the set of reaction options further causes the system perform:
determining the set of reaction options based at least in part on one or more preferences of a user operating the computing device.

16. A non-transitory computer-readable storage medium including instructions that, when executed by at least one processor of a computing system, cause the computing system to perform a method comprising:
obtaining data describing at least one content item from a social networking system;
determining a customized set of reaction options to be provided with the content item, the customized set of reaction options including a plurality of different options for expressing at least one reaction toward the content item, wherein each reaction is associated with at least a corresponding icon; and
presenting (i) the content item and (ii) at least a portion of the customized set of reaction options through a display interface.

17. The non-transitory computer-readable storage medium of claim 16, wherein the computing system further performs:
determining that a user operating the computing device has performed an operation to expand the set of reaction options; and
presenting the set of reaction options through the display interface in its entirety.

18. The non-transitory computer-readable storage medium of claim 16, wherein determining the set of reaction options further causes the computing system perform:
obtaining information describing the respective counts for each reaction option in the set, wherein a count for a reaction option indicates a number of other users of the social networking system that selected the reaction option for the content item; and
determining an ordering for the set of reaction options based at least in part on the respective counts.

19. The non-transitory computer-readable storage medium of claim 16, wherein determining the set of reaction options further causes the computing system perform:
determining the set of reaction options based at least in part on a geographic location corresponding to the computing device.

20. The non-transitory computer-readable storage medium of claim 16, wherein determining the set of reaction options further causes the computing system perform:
determining the set of reaction options based at least in part on one or more preferences of a user operating the computing device.
